(19) United States
(12) Patent Application Publication
(10) Pub. No.: US 2005/0162870 A1
(43) Pub. Date: Jul. 28, 2005

(54) Power converter

(76) Inventor: B. Mark Hirst, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/764,409

(22) Filed: Jan. 23, 2004

(51) Int. Cl. H02M 3/335

(52) U.S. Cl. 363/16

(57) ABSTRACT

Embodiments of methods, systems, devices and/or circuits for a power converter are described.

### BACKGROUND

This disclosure is related to power converters, such as AC to DC converters, for example.

Power conversion usually results in some amount of power loss as a result of the conversion process. One example is conversion from alternating current (AC) to direct current (DC) power. Thus, new methods and/or techniques to accomplish power conversion, which result in improved efficiency, continues to be desirable.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a block diagram illustrating a high-level description of one potential embodiment of a power converter;

FIG. 2 is a circuit diagram illustrating another potential embodiment of a power converter; and

FIG. 3 is a schematic diagram of an embodiment illustrating a typical application of a power converter.

### DETAILED DESCRIPTION

Embodiments of systems, apparatuses, devices and/or methods for time slotting power switching are described. In the following description, numerous specific details are set forth. However, it is understood that the described embodiments may be practiced without these specific details. In other instances, well-known circuits, structures and/or techniques have not been shown in detail so as not to unnecessarily obscure the provided description.

Reference throughout this specification to “one embodiment” and/or “an embodiment” means that a particular feature, structure, and/or characteristic described may be included in at least one embodiment. Thus, the appearance of the phrases “in one embodiment” or “in an embodiment” in various places throughout this specification typically do not refer to one particular embodiment or the same embodiment. Furthermore, various features, structures, and/or characteristics described through out this specification may be combined in any suitable manner in one or more embodiments.

Power conversion usually results in some amount of power loss as a result of the conversion process. One example is conversion from alternating current (AC) to direct current (DC) power. Thus, new methods and/or techniques to accomplish power conversion, which result in improved efficiency, continues to be desirable.

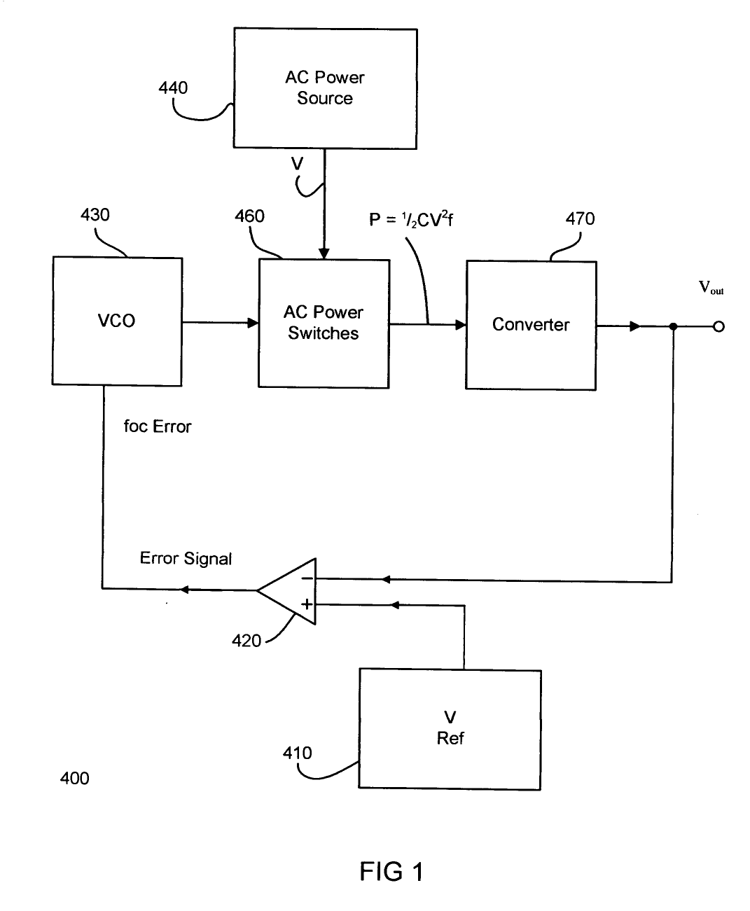

FIG. 1 is a block diagram illustrating at a high-level one embodiment of a power converter. This particular embodiment, designated 400 in FIG. 1, converts from AC power to DC power, although the claimed subject matter is not limited in scope to only AC to DC power conversion. Embodiment 400 includes an AC power switch or switches 460. This power switch or switches may comprise any form, such as, relays, bipolar transistors, field effect transistors (FETs), metal oxide semiconductor (MOS) transistors and the like. As further illustrated in FIG. 1, a voltage, V, is applied to switch or switches 460 by an AC power source 440. Likewise, a voltage-controlled oscillator (VCO) 430 provides a frequency of switching, f, to switch or switches 460. Thus, AC power is applied to a power converter 470 by switch or switches 460. Although the claimed subject matter is not limited in scope in this respect, for this particular embodiment, the power converter may take the form of an isolation transformer, as described in more detail hereinafter. Likewise, for this particular embodiment, the power applied may be expressed by the following relationship:
P=½ C V²f [1]

where P is power; C is a constant, which for an embodiment employing a charge pump, for example, may be related to capacitance, as explained in more detail hereinafter; V is root-mean-square (RMS) voltage of the AC power source applied; and f is the switching frequency. Thus, for this embodiment, power varies substantially linearly with the switching frequency.

Feedback may be accomplished by employing VCO 430 in conjunction with a reference voltage level 410 and an error amplifier 420, although, this is just one example, and many different schemes for feedback are included within the scope of the appended claims. Thus, in this particular embodiment, the voltage output signal, V_{OUT}, produced by converter 470 is compared with a voltage reference signal level, V_{ref} 410, and the error or difference is applied to VCO 430. As a result, VCO 430 may adjust the switching frequency which may affect the power and, likewise, the voltage output signal.

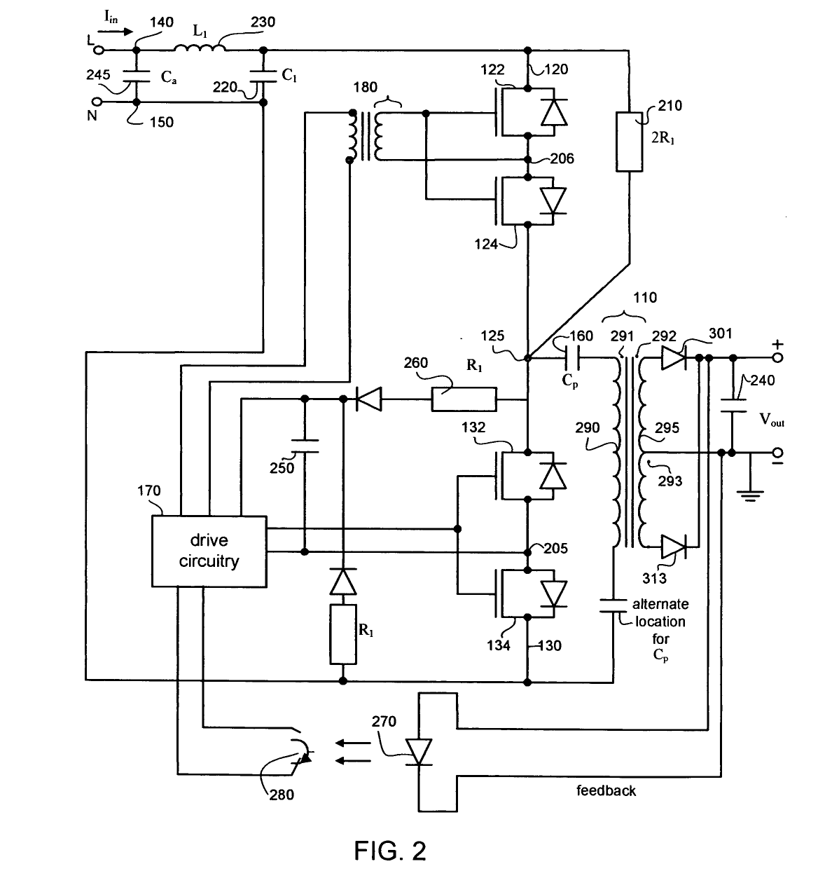

FIG. 2 is a circuit diagram illustrating another potential embodiment. Although FIG. 2 is a circuit diagram, it is understood that FIG. 2 excludes details unnecessary to convey an understanding of the subject matter. For example, switch turn-off protection snubbers and/or regenerative charge pump snubbers are not illustrated. Likewise, this is an additional example embodiment and the claimed subject matter is not limited in scope to this particular embodiment. Many other embodiments are possible that fall within the scope of the claimed subject matter.

Referring now to FIG. 2, embodiment 100 again depicts one potential implementation of an AC to DC converter, but the claimed subject matter is not limited to AC to DC converters. For example, other power converters, such as DC-DC converters, current-to-voltage converters and the like, for example, may fall within the scope of the claimed subject matter. However, this particular embodiment includes an isolation transformer 110. This particular embodiment specifically comprises a voltage fed, series resonant, transformer-isolated AC-DC power converter. More specifically, voltage is directly being applied to transformer coil 290 and coil 290 is in a circuit loop in series with other circuit components to produce frequency resonant operation when voltage is applied.

This embodiment also comprises here two transistor totem-pole configurations, 120 and 130; configuration 120 is coupled here to an AC Line 140 and configuration 130 is coupled to an AC Neutral 150. Likewise, a port or terminal of pump capacitance device 160 couples between configurations 120 and 130 at location 125 to drive or apply voltage to coil 290 of transformer 110 via the other port or terminal of capacitance device 160. It is noted, however, that alternatively, the pump capacitance device may be coupled between coil 290 and configuration 130, as shown. Thus, either location may be employed, depending on desirability. However, if the alternate location were not employed, for this embodiment, coil 290 would be coupled to configuration 130 through a short circuit connection. It is noted that, for this particular embodiment, the transistors comprise N-type metal oxide semiconductor field effect transistors, here MOSFETS, although, of course, the claimed subject matter is not limited to MOS devices, FET devices, N-type or P-type devices, or even to employing transistors. However, in this embodiment, configuration 120 comprises MOSFETs 122 and 124 and configuration 130 comprises MOSFETS 132 and 134. Likewise, it is noted that the diodes depicted in FIG. 2 as across the respective MOSFETs comprise parasitic diodes. Thus, coupling the MOSFETS to form a totem pole configuration, as illustrated for this particular embodiment, provides a benefit in that the parasitic diodes oppose one another here.

Drive circuitry 170 drives the MOSFETs for this particular embodiment, as further illustrated in FIG. 2. For configuration 120, a gate drive transformer 180 drives MOSFETs 122 and 124, although, of course, the claimed subject matter is not limited to employing a gate drive transformer. As an example, an optical-isolator approach might have alternatively been employed. Electrical isolation may be desirable here so that a voltage may be employed with configuration 120 that exceeds the bias voltage of drive circuitry 170.

Embodiment 100 includes other components illustrated in FIG. 1. For example, an input power filter is formed by inductance 230, designated L₁, capacitance 220, designated C₁ and capacitance 245, designated Cₐ. This input power filter is commonly referred to as a ‘pi’ filter due to the structure resembling the shape of the mathematical symbol π. This filter may be employed at least in part to smooth the high frequency discontinuous current supplied to isolation transformer 110 such that the resulting current flowing through L₁ is a relatively smooth continuous current with a relatively small amount of ripple current. The ripple current will, in general, approximate a sinusoid with several frequency components. The dominant ripple current frequencies are at the drive frequency of the MOSFETs and at the resonant frequency of capacitor 160 and transformer 110.

In some embodiments, the capacitance of 220 may be generally 10 times as large as the capacitance of 245 or more. The values of inductance 230 and capacitance 220 may be selected such that their resonant frequency is in the order of ⅕ of the lower end of the desired drive frequency of the switches in the power converter for this embodiment. In addition, for this embodiment, the values of inductance 230 and capacitance 220 may be further selected such that their resonant frequency is approximately ten times the frequency of the input AC power supplied at input terminals 140 and 150. For example, capacitor 220 may have a value of approximately 4 uF and capacitor 245 may have a value of approximately 0.44 uF. Likewise, inductor 230 may have a value of approximately 100 uH. Of course, these are just example values. Thus, depending on the particular embodiment, a variety of factors may play into the selection of components, such as filtering the 50 to 60 Hz AC input current to reduce the AC ripple current component, filtering conducted emissions to reduce any potential injection into the AC power source. In general, for this particular embodiment, it is desirable to choose component values that are substantially in accordance with the following relationship:
1/(2π((L₁C₁)\hat{ }1/2))<f<1/(2π((L_{T}C_{P})\hat{ }1/2)) [2 ]

where L_{T} refers to the inductance of transformer 110 and the other values are defined in FIG. 2.

In cases where the power transfer may be limited by the switch frequency becoming nearly equal to the resonant frequency of Cₚ and L_{T}, the value of Cₚ may likewise be adjusted to increase the energy transferred on a switch transition. For example, increasing Cₚ by a factor of 2 may double the energy transferred with a switch transition, although this occurs at the cost of decreasing the allowable switch frequency by a factor of 1/(square root of 2). After applying relationship [1], however, the end result is an increase by a factor of the square root of two (or approximately 1.414) in the power that the converter can transfer.

Referring again to FIG. 2, capacitor 250 and resistor 260 together provide a mechanism to bias drive circuitry 170 during the period of the cycle in which pump capacitor 160 is inactive or recharging. Resistance 210 is coupled across configuration 120 to supply bias current to power drive circuit 170 when configurations 120 and 130 are both turned “off.” It is, of course, appreciated that the claimed subject matter is not limited in scope to a circuit that includes discrete components. Thus, circuit components or elements that primarily provide resistance, inductance and/or capacitance (but not exclusively) will provide more than adequate performance and are included within the scope of the claimed subject matter. In this context, such elements and/or components may be referred to hereinafter as resistors, inductors and/or capacitors, respectively. Thus, pump capacitance device 160, for example, which may be implemented on an IC in silicon, for example, may be referred to hereinafter as capacitor 160 without loss of generality.

In this particular embodiment, an optical-electronic-isolation system is employed to provide a feedback signal, although, of course, many other mechanisms may be employed to provide feedback and remain within the scope of the claimed subject matter, such as, for example, as described in connection with FIG. 1, for example. Furthermore, some embodiments within the scope of the claimed subject matter may not necessarily employ a feedback mechanism; however, in this particular embodiment, a light-emitting diode 270 may provide a feedback signal to an optical receptor device 280, such as an opto-electronic transistor, for example. Thus, device 280, for example, may impact the operation of drive circuitry 170 to adjust the frequency of the drive signal applied via drive circuitry 170 to gate drive transformer 180, in this particular embodiment.

Embodiment 100 of FIG. 2 may operate in accordance with the following method, although, of course, the claimed subject matter is not limited in scope to this particular method embodiment. An input AC signal may be applied to the input filter components, capacitor 245, inductor 220 and capacitor 230. The filtered signal is, thus, applied across configurations 120 and 130, and, thus, across coil 290 of isolation transformer 110. The secondary of transformer 110 are coupled in this particular embodiment to diodes 301 and 303 to create a center tapped full wave rectifier. Capacitor 240 provides bulk capacitance to supply current and stabilize Vₒᵤₜ when diodes 301 or 303 are not conducting.

Assuming that drive circuitry 170 applies a drive signal to gate drive transformer 180, transistors 122 and 124, here MOSFETs, turn on and conduct current while transistors 132 and 134 are turned off and are in a nonconductive state. As a result, charge pump capacitor 160 charges with an assumed positive charge at junction 125. Capacitor 160 and the inductance of transformer 110 form a resonant system such that the current flowing through 160 and primary winding 290 smoothly resonates in a sinusoidal fashion until capacitor 160 is fully charged. Current flows through primary winding and the magnetic circuit of transformer 110 results in current flowing in secondary winding 295. FIG. 2 includes several symbols referred to as dots. Dots 291, 292 and 293 are labeled on transformer 110. According to magnetic circuit dot notation rules, a current flow into dot 291 causes a current to flow out of dot 292 and out of dot 293. Diode 301 conducts when current flows out of dot 292, thus transferring energy to bulk storage capacitor 240. Diode 303 is configured to inhibit current flow out of dot 293 when current is flowing into dot 291. After the capacitor is fully charged, configuration 120 will remain in a conducting state, even though no current is flowing, until drive circuitry 170 starts the discharge cycle.

Drive circuitry 170 is designed so that after the drive signal to gate drive transformer 180 is no longer applied, a delay of approximately 100 nanoseconds (ns) is applied before a drive signal is applied to drive transistors 132 and 134 of configuration 130. This delay is commonly referred to as a “blanking interval.” The delay reduces the risk of energizing configuration 130 before current has stopped flowing in configuration 120. Another blanking interval is applied after turning off configuration 130 and before turning on configuration 120. It is noted that there are many different mechanisms to create the blanking interval or a time delay, and the claimed subject matter is not limited to any particular approach. For example, an RC circuit may be employed or, alternatively, a digital delay might be employed, to provide only a few examples.

Once configuration 130 is energized a resonant current starts reverse flow through capacitor 160 and primary winding 290. Capacitor 160 and the inductance of transformer 110 are again a resonant system such that the current flowing through 160 and primary winding 290 smoothly resonates in a sinusoidal fashion until capacitor 160 is fully discharged. Reverse current flow through primary winding 290 of the magnetic circuit of transformer 110 results in a reverse current flowing in secondary winding 295. In this case, a current is flowing out of dot 291 which induces a current to flow into dots 292 and 293. Diode 301 now inhibits a current flow into dot 292 while diode 303 allows a current flow into dot 293, thus, transferring energy to the bulk storage capacitor 240.

The previously described embodiment provides a variety of advantages, although the claimed subject matter is not necessarily limited in scope to embodiments that have these advantages. This particular embodiment, for example, allows direct AC to DC power conversion without rectification on the AC primary side of the system and yields a power transfer that is at least substantially a linear function of drive frequency. This embodiment also allows the transistors to be turned on and off at substantially zero current, thus reducing the switch losses and improving power converter efficiency. Furthermore, the topology of the design reduces AC current harmonics by selecting f substantially in accordance with relationship [2] and provides a near unity power factor for reasonable loads without the cost, circuit complexity, and/or power loss of additional power factor correction circuitry. Likewise, the elimination of primary rectification and the use of substantially zero-current transistor switching rather than hard switching reduce radiated emissions and conducted emissions, which may be the subject of regulatory limits in some situations.

As implied by relationship [2] above, it may be desirable to select the switching frequency to be lower than that of the resonant frequency of the charge pump capacitor and the inductance of the isolation transformer, although the claimed subject matter is not limited in scope in this respect. Damping in this particular embodiment is relatively high which allows the converter switching frequency to range from a relatively low frequency, such as 10 kHz up to near the resonant frequency. For this embodiment, power transfer is substantially a linear function of frequency given by relationship [1], previously provided and repeated below:
P=½ C V² f [1]
where, here, P is power, C is now the value of charge pump capacitance 160, V is the RMS voltage of the power source applied to terminals 140 and 150 of the power converter and f is the switching frequency of the power converter.

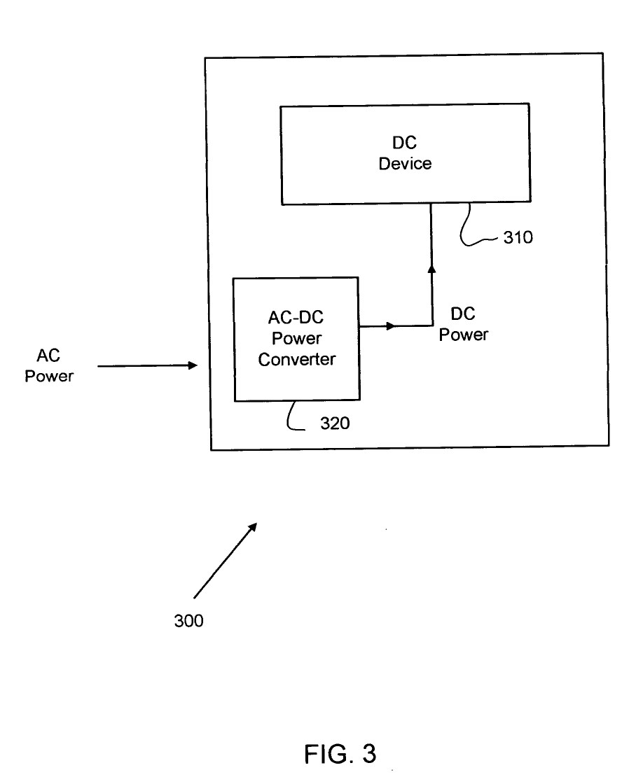

For example, an embodiment of an AC-DC converter, such as previously described, as one example, may be employed as demonstrated in FIG. 3. Embodiment 300 here comprises a DC voltage consuming device 310 and an AC-DC power converter 320. As illustrated, embodiment 300 may be coupled to an AC power source in order to receive AC power, such as an AC voltage. Here, converter 320 may then be employed to convert an AC voltage to a DC voltage. The DC voltage produced by converter 320 may then be applied to device 310. Here, device 310 may comprise any one of a number of devices that consume DC power, such as, a desk-top computer, a laptop computer, a motherboard for such devices, a PDA or other hand-held computing device, and/or a similar computing device. Likewise, device 310 may comprise an appliance, such as a coffee maker and/or an alarm clock, a consumer electronic device, such as audio equipment, a DVD player, a CD player, a TV, a camera, such as a digital camera, and/or more. Device 310 may comprise a communications device, such as a telephone, a wireless phone, a networking communications device, such as a router, a hub, and/or more. Device 310 may also comprise a peripheral device, such as a computer peripheral, including, for example, a fax, a copier, a printer, a scanner and/or more. Likewise, device 310 may comprise combinations of the foregoing devices and/or DC power consuming devices not mentioned explicitly, including combinations. The claimed subject matter, therefore, is intended to cover any and all DC power consuming devices currently known or to be developed later.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

1. An apparatus comprising:
a power converter;
said power converter including a charge pump capacitor, said charge pump capacitor coupled in said converter so as to drive a primary of an isolation transformer without signal rectification.

2. The apparatus of claim 1, wherein said charge pump capacitor is coupled to drive the primary of an isolation transformer without signal rectification at least in part by being adapted to switch between charging and discharging operation at different portions of a current cycle.

3. The apparatus of 2, wherein said charge pump capacitor is further adapted to switch between charging and discharging operation at or substantially near zero current.

4. The apparatus of claim 1, wherein said power converter is incorporated on a motherboard.

5. The apparatus of claim 1, wherein said power converter is coupled to a DC power consuming device.

6. The apparatus of claim 5, wherein said DC power consuming device comprises at least one of a fax, printer, scanner, and copier.

7. The apparatus of claim 1, wherein said power converter comprises an AC-DC power converter.

8. The apparatus of claim 7, wherein said power converter includes an input pi filter.

9. The apparatus of claim 7, wherein a secondary of said isolation transformer is coupled in a circuit to perform full-wave rectification.

10. The apparatus of claim 1, wherein said primary of said isolation transformer is coupled so as to resonate during operation.

11. A circuit comprising:
a power converter;
said power converter comprising at least two transistor totem-pole configurations; one of said configurations coupled to an AC line and another of said configurations coupled to an AC neutral; a pump capacitance device coupled between said configurations to drive a primary of an isolation transformer.

12. The circuit of claim 11, wherein said isolation transformer is coupled in said power converter to form a series fed, resonant, isolation transformer.

13. The circuit of claim 11, wherein said transistor configurations are coupled in said converter so to yield a power transfer that is substantially a linear function of switching frequency.

14. The circuit of claim 11, wherein said transistor configurations are coupled in said converter so as to turn at least some of the transistors of said configurations on at substantially zero current.

15. The circuit of claim 14, wherein said transistor configurations are coupled in said converter so as to turn at least some of said transistors of said configurations off at substantially zero current.

16. The circuit of claim 15, wherein said transistor configurations are coupled in said converter so as to turn all of said transistors of said configurations on and/or off at substantially zero current.

17. The circuit of claim 11, wherein at least one of said transistors comprises a MOSFET.

18. The circuit of claim 11, wherein said pump capacitive device comprises a capacitor.

19. The circuit of claim 11, wherein said power converter is incorporated into a motherboard.

20. The circuit of claim 1, wherein said power converter is coupled to a DC power consuming device.

21. The circuit of claim 20, wherein said DC power consuming device comprises at least one of a fax, printer, scanner, and copier.

22. The circuit of claim 11, wherein said power converter comprises an AC-DC converter.

23. The circuit of claim 11, wherein said power converter includes an input pi filter.

24. The circuit of claim 11, wherein a secondary of said power converter is coupled so as to provide full wave rectification.

25. A method of converting power comprising:
charging an electrical storage element during a portion of a cycle so that current is provided by said electrical storage element during another portion of the cycle without rectification.

26. The method of claim 25, wherein said electrical storage element is charged during resonant operation of a primary circuit of an isolation transformer.

27. The method of claim 25, wherein charging and discharging of said electrical storage element switches at substantially zero current.

28. The method of claim 27, wherein transistor configurations are employed to accomplish the switching.

29. The method of claim 28, wherein said transistor configurations include MOSFETs arranged in a totem pole configuration.

30. The method of claim 28, wherein power is converted as substantially a linear function of switching frequency.

31. The method of claim 25, wherein said electrical storage element comprises a charge pump capacitor.

32. The method of claim 25, wherein feedback is employed for synchronization between an applied input voltage signal and an output voltage signal.

33. The method of claim 25, wherein converting power comprises AC to DC conversion.

34. A system comprising:
a DC power consuming device and an AC-DC power converter;
said power converter including a charge pump capacitor, said charge pump capacitor coupled in said converter so as to drive a primary of an isolation transformer without signal rectification.

35. The system of claim 34, wherein said charge pump capacitor is coupled to drive the primary of an isolation transformer without signal rectification at least in part by being adapted to switch between charging and discharging operation at different portions of a current cycle.

36. The system of 35, wherein said charge pump capacitor is further adapted to switch between charging and discharging operation at or substantially near zero current.

37. The system of claim 34, wherein said power converter is incorporated on a motherboard with said DC power consuming device.

38. The system of claim 34, wherein said DC power consuming device comprises at least one of a fax, a printer, a scanner and a copier.

39. The system of claim 34, wherein said power converter comprises an AC-DC power converter.

40. The system of claim 39, wherein said power converter includes an input pi filter.

41. The system of claim 39, wherein a secondary of said isolation transformer is coupled in a circuit to perform full-wave rectification.

42. The system of claim 34, wherein said primary of said isolation transformer is coupled so as to resonate during operation.

43. An apparatus comprising:
means for converting from an AC voltage to a DC voltage;
said means for converting including a means for isolation, said means for isolation including a primary and a secondary;
said means for converting being coupled so that, in operation, AC to DC voltage rectification does not occur on the primary side of said means for isolation.

44. The apparatus of claim 43, wherein said means for converting is coupled to drive the primary of said means for isolation without signal rectification at least in part by being adapted to switch between charging and discharging operation at different portions of a current cycle.

45. The apparatus of 44, wherein said means for converting includes a charge pump capacitor, said capacitor being further adapted to switch between charging and discharging operation at or substantially near zero current.

46. The apparatus of claim 43, wherein said means for converting is incorporated on a motherboard.

47. The apparatus of claim 43, wherein said means for converting is coupled to a DC power consuming device.

48. The apparatus of claim 47, wherein said DC power consuming device comprises at least one of a fax, printer, scanner, and copier.

49. The apparatus of claim 43, wherein said means for converting comprises an AC-DC power converter.

50. The apparatus of claim 49, wherein said power converter includes an input pi filter.

51. The apparatus of claim 49, wherein the secondary of said means for isolation is coupled in a circuit to perform full-wave rectification.

52. The apparatus of claim 43, wherein said primary of said means for isolation is coupled so as to resonate during operation.
